(19) United States
(12) Patent Application Publication
(10) Pub. No.: US 2003/0033839 A1
(43) Pub. Date: Feb. 20, 2003

(54) Mortise latch apparatus

(76) Inventors: Holly Chen, Rice Lake, WI (US); Michael W. Kondratuk, Cameron, WI (US)

Correspondence Address: MERCHANT & GOULD PC, P.O. BOX 2903, MINNEAPOLIS, MN, 55402-0903, US

(21) Appl. No.: 09/929,830

(22) Filed: Aug. 14, 2001

(51) Int. Cl. E05B 59/00; E05B 63/14

(52) U.S. Cl. 70/107

(57) ABSTRACT

A latch includes a mortise lock assembly having a sliding live bolt and dead bolt. A spindle connected to opposed handles actuates the live bolt. The dead bolt includes a cam restrained by mechanical stops and a follower moving in a limited range of motion in a slot formed in the side of the lock housing. An oval key cylinder engages the cam and is mounted on an escutcheon plate. The key cylinder includes a spindle with approximately one-quarter turn of free relative rotation. The key cylinder spindle mounts to a thumb turn button so that the spindle may be actuated through one-quarter turn by either the thumb turn button or the key cylinder.

### BACKGROUND OF THE INVENTION

1. Field of the Invention

The present invention is directed to a latch with a mortise lock, and in particular, to a latch for a storm door that is reversibly mountable and includes a dead bolt lock with a cam and lock body, and a key cylinder mounted on an escutcheon plate.

2. Prior Art

Mortise locks are well known and have been used for solid wood doors for years and for storm doors more recently. Mortise locks generally require extensive door face preparation, which is done by the door manufacturers due to the complexity of the preparation. The key cylinders used in existing mortise locks use a key cylinder having a profile with a wide main portion and an arm portion extending radially outward therefrom. Therefore, the mounting hole formed in the face of the door must accommodate the unusual shape. Although simple preparation such as drilling through the door is preferred, the nature of the key cylinder shape and dimensions with the large radially extending portion would require a drilled hole with an impractically large diameter. A hole having such a large diameter would require hardware such as widened escutcheon plates to cover the hole, making the latch less aesthetically pleasing. Therefore, a slot-type opening must be made through the faces of the door to accommodate currently known key cylinders. This preparation requires special tools and is much more difficult, time intensive and expensive than simple drilling. Homeowners do generally not undertake such complex preparation.

Another common problem with existing mortise locks is the actuation of the dead bolt. A cam that engages a corresponding slot in the dead bolt typically actuates mortise lock dead bolts. The cam may be over rotated and exit the slot and disengage the dead bolt with the dead bolt stopped in a position wherein the cam cannot reenter the dead bolt. This may occur with the dead bolt still partially extended, resulting in a lockout condition. Since the cam cannot be reengaged, and the dead bolt is extended, it is sometimes necessary to break down the door, resulting in damage to both the frame and the door. This often ruins the door, lock and/or the door frame.

Mortise locks with dead locks typically have a single throw, with full rotation, or double throw, with two full rotations for dead bolt actuation. With both types of actuation, the lock looks the same whether locked or unlocked. This becomes confusing to the operator, as it is difficult to determine whether the dead bolt is in the locked or unlocked position by simple visual inspection. A thumb turn on the inside of the door is typically oriented in the same direction whether the door is locked or unlocked.

Another shortcoming with many current mortise locks is that they are not reversible. Current locks require door face preparation to accept the locks. With mounting of current locks, it would be necessary to make mounting slots or holes in the face of the door near both edges. With the lock of the present invention, the door face can be easily prepared after a side is selected so that only one set of mounting orifices is needed and the door does not require flipping to reverse it for opening to the left or the right.

It can be seen that a new and improved mortise latch is needed that overcomes the problems associated with the prior art. Such a latch should provide easy mounting through the face of the door with simple preparation such as round bores being formed through the door with typical drilling and using standard escutcheon plates. Moreover, such a latch should provide for reversibly mounting to either face of the door in an orientation allowing opening in either direction. The dead bolt should include a thumb turn button extending at a different orientation between the locked and unlocked position so that it can easily be determined whether the door is unlocked or locked by a quick visual scan. An improved mortise lock should also provide for reliable engagement of the cam in the dead bolt that prevents the rotation of the cam beyond the intended range of motion, resulting in disengagement and a lockout condition. The present invention addresses these as well as other problems associated with mortise latches.

### SUMMARY OF THE INVENTION

The present invention is directed to a latch with a mortise lock, and in particular to a mortise lock that provides more reliable actuation of the dead bolt as compared to the prior art. A mortise latch includes a lock assembly having opposed side plates with a dead bolt and live bolts intermediate the side plates. The bolts slide between retracted and extended positions beyond the edge of the door. Opposed handles having a spindle extending through an actuator engaging the live bolt actuate the live bolt.

The dead bolt mechanism includes a cam engaging the dead bolt and a stop extending into a slot formed in one of the side plates to guide and limit motion of the dead bolt. In addition, mechanical stops extending between the plates engage an arm on the cam to prevent rotation beyond the predetermined fully retracted and fully extended positions. A spindle extending from the key cylinder through a slot in the cam to a thumb turn button actuates the cam. Approximately 90 degrees of free relative rotation is provided between the spindle and the key cylinder so that either the key cylinder or the thumb turn button may actuate the dead bolt. The thumb turn button has crossed perpendicular mounting slots so that it may be properly oriented for each left hand or right hand mounting positions. In this manner, the lock is actuated with only approximately 90 degrees of rotation so that a visual scan of the thumb turn button may easily provide an indication whether the dead bolt is locked or not.

The cam extends up into the recess in the dead bolt. The recess includes a follower biased against the arm by a spring. The follower connects to the stop, sliding in the slot in the side plate. The slot includes a tab extending upward therein forming spaced apart channels so that the follower must proceed from a channel on one side of the tab to a channel on the other side of the tab, up and over the tab to move between the locked and unlocked position. The arm extends slightly into the recess at all times and pushes the stop and the follower up when rotated so that the follower clears the tab in the slot. The positive stops prevent the arm from disengaging the dead bolt and suffering from over rotating to a lockout position, as may occur with the prior art.

The key cylinder of the present invention has a substantially oval shape rather than a round portion with an arm extending radially therefrom. The oval shape provides for fitting in a much smaller diameter bore formed in the door for receiving the key cylinder and a standard escutcheon plate. This allows for drilling of a standard round bore, rather than forming a slot through the door to accept the key cylinder. A smaller diameter bore and a second bore for receiving the spindle of the live bolt intersects with the mortise. Preparation of the door is much simpler, as only round bores are needed to be drilled into the face of the door, rather than slots being formed, as required by prior mortise latches. The key cylinder also mounts to the escutcheon plate and provides for much narrower lock assemblies than those required with the prior art.

These features of novelty and various other advantages that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals indicate corresponding structure throughout the several views:

FIG. 1 is a front top prospective view of a mortise latch apparatus according to the principles of the present invention;

FIG. 2 is a rear top prospective view of the latch apparatus shown in FIG. 1;

FIG. 3 is an exploded side view of the of the latch apparatus shown in FIG. 1;

FIG. 4 is a front is a front perspective view of the latch apparatus shown in FIG. 1 mounted to a door;

FIG. 5 is a partially exploded perspective view of the lock assembly for the latch apparatus shown in FIG. 1;

FIG. 6 is a partially exploded view of an escutcheon assembly for the latch apparatus shown in FIG. 1;

FIG. 7 shows a plan view of the dead bolt and cam for the latch apparatus shown in FIG. 1 in the extended locked position;

FIG. 8 shows a plan view of the dead bolt and cam shown in FIG. 7 in a partially retracted position;

FIG. 9 shows a plan view of the dead bolt and cam shown in FIG. 7 in the retracted position;

FIG. 10 shows a perspective view of an edge of a storm door prepared to receive a mortise latch according to the principles of the present invention; and

FIG. 11 shows a partially exploded perspective view of an inner escutcheon assembly.

### DETAILED DESCRIPTION OF THE PREFERRED EMBODIMENT

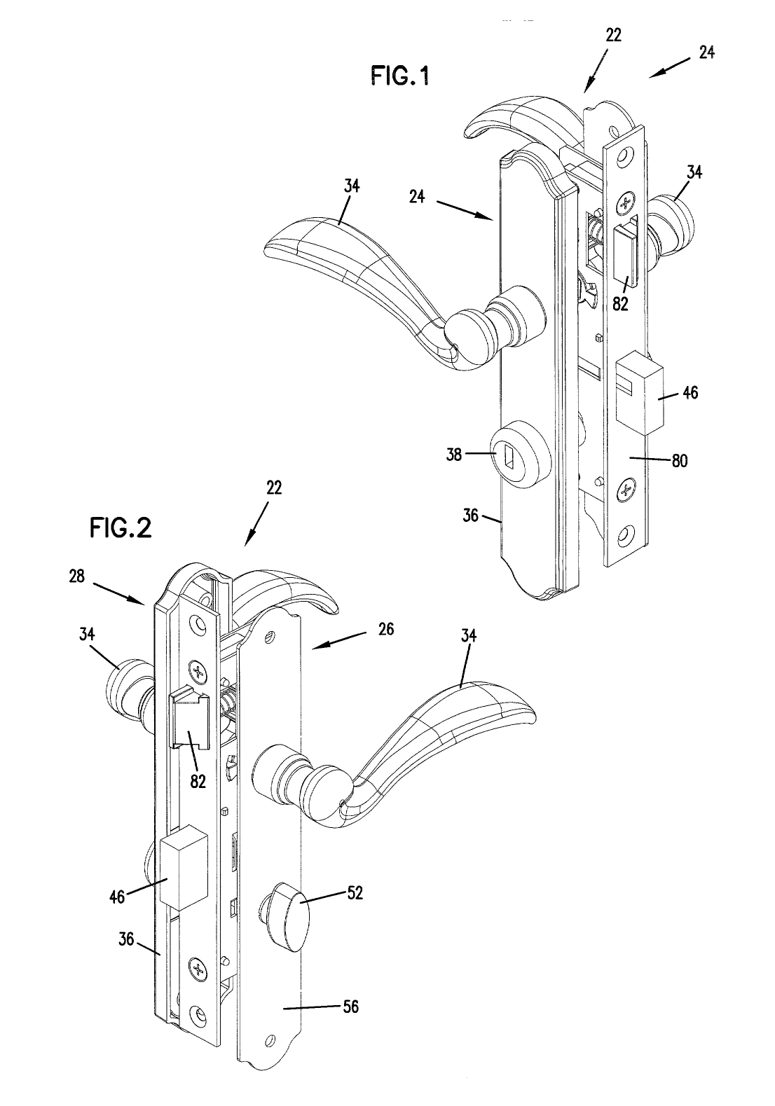

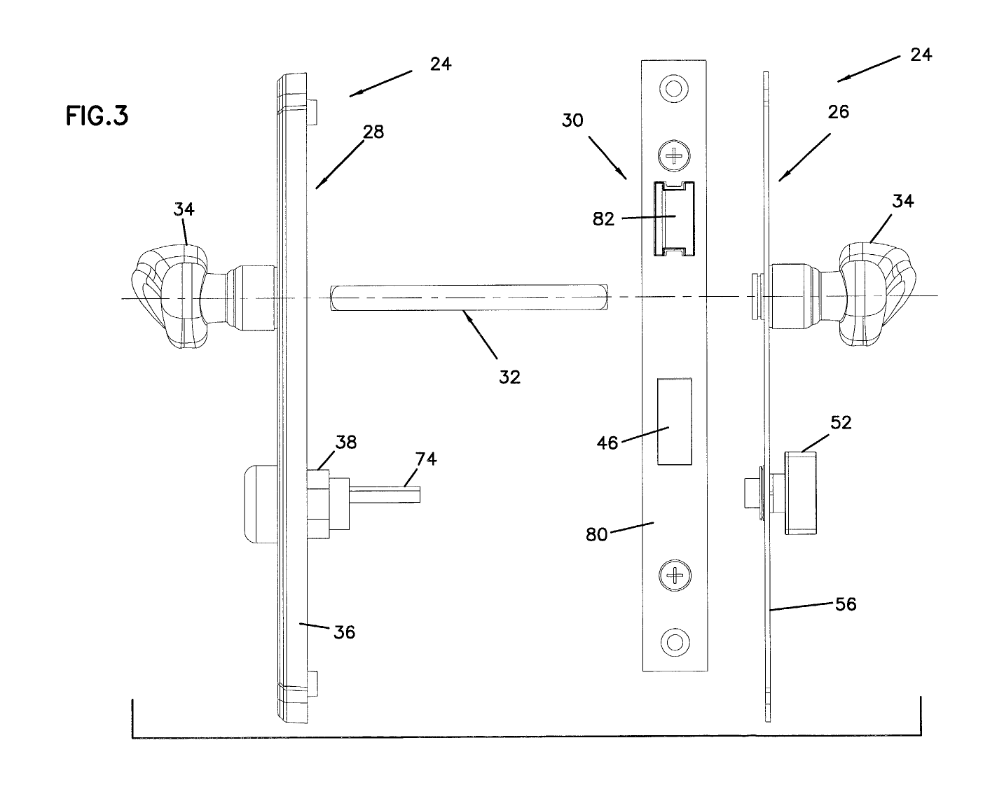

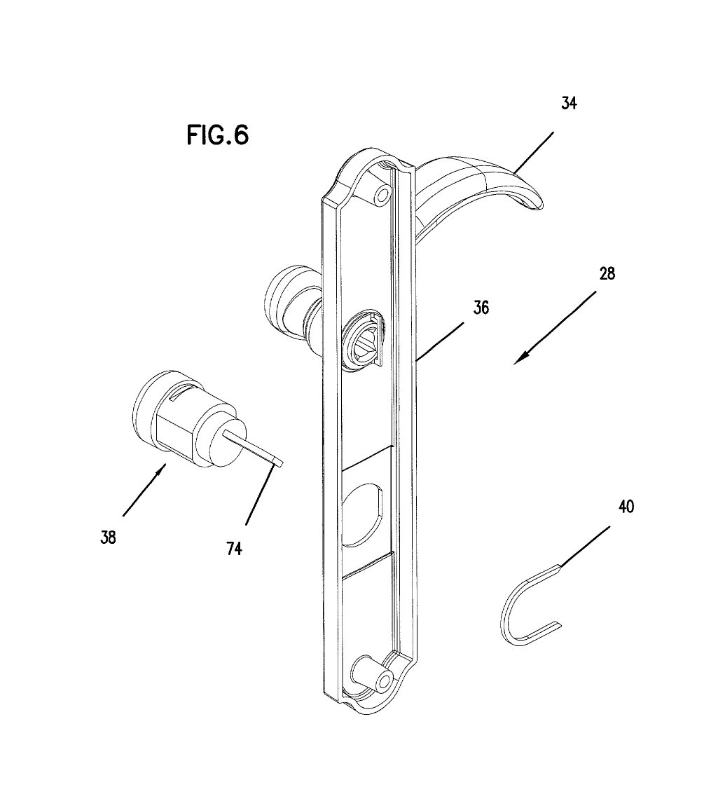

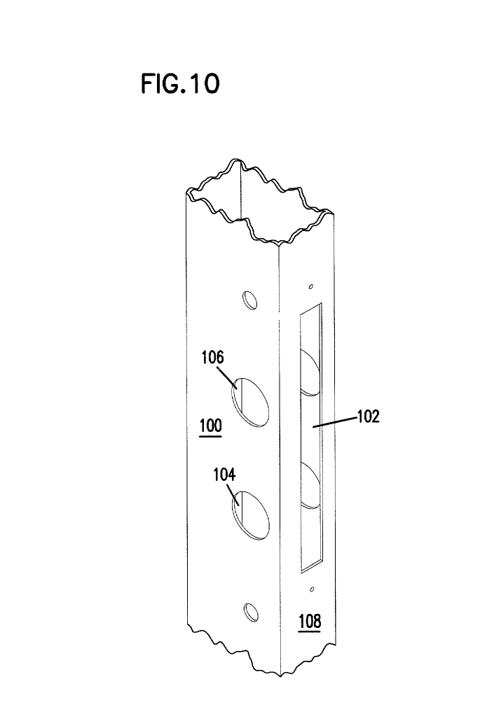

Referring now to the drawings, wherein like reference numerals and letters indicate corresponding structure throughout the several views, and referring in particular to FIG. 1, there is shown a latch, generally designated 22. The latch 22 mounts to a storm door, generally designated 20 and shown in FIG. 10. The latch 22 includes an escutcheon assembly 24 including an escutcheon plate 36 and key cylinder 38. As shown in FIG. 3, the latch 22 has a mortise lock assembly 30 that can be inserted through the edge of the door. The escutcheon assembly 24 has an inner portion 26 and outer portion 28. A spindle 32 extends between handles 34 through the lock assembly 30. Referring to FIG. 6, the outer portion 28 of the escutcheon assembly 24 includes an escutcheon plate 36 having an orifice formed therein for receiving the key cylinder 38. The handle 34 rotatably mounts to an upper portion of the escutcheon plate 36. The key cylinder 38 includes a channel receiving a retainer clip 40 for retaining the key cylinder 38 against the escutcheon plate 36. The key cylinder 38 includes a spindle portion 74 extending therefrom to actuate the dead bolt, as explained hereinafter. It will be appreciated that unlike prior art devices, wherein the key cylinder would include a radial arm extending therefrom, the key cylinder 38 has a substantially oval profile. This provides for easy insertion through a round drilled bore with a substantially decreased diameter as compared to the diameters required by prior art key cylinder devices. The inner escutcheon assembly 26 includes a mounting plate 56 receiving the handle 34 and the thumb turn button 52.

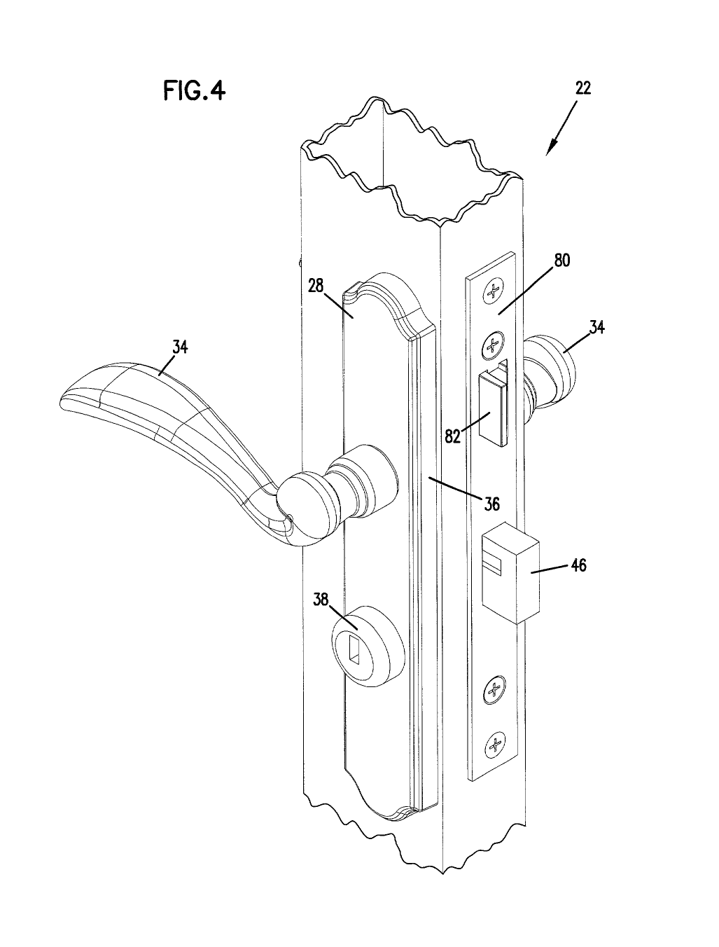

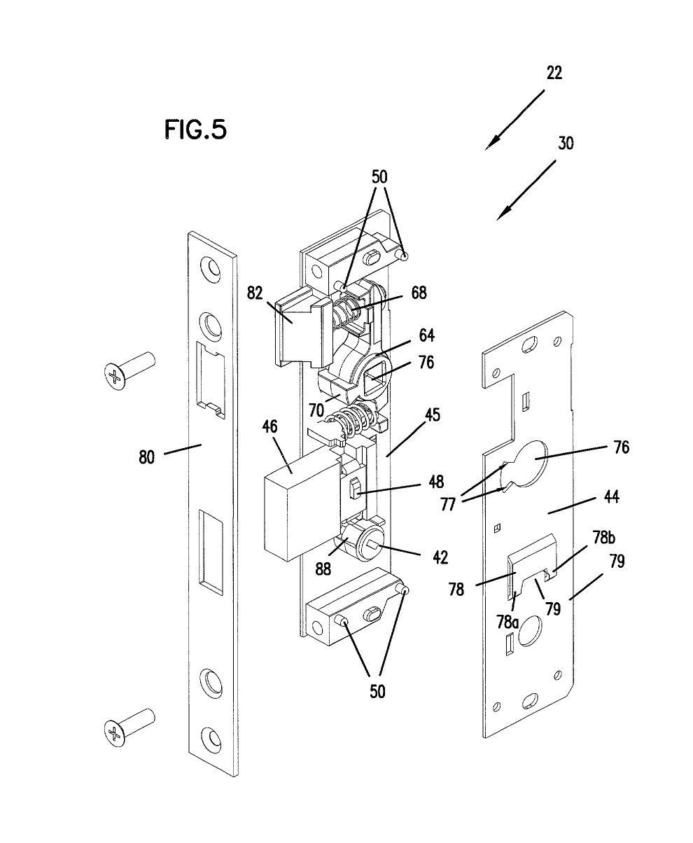

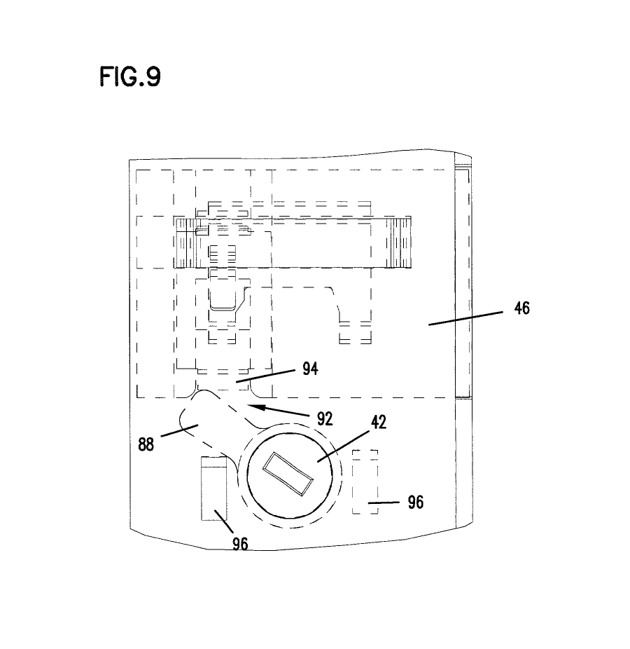

Referring to FIG. 10, the door body 100 includes a mortise 102 formed into one edge 108. The mortise 102 receives the lock assembly 30 (not shown in FIG. 10). In addition, a first round bore 104 and a second round bore 106 are formed therein spaced apart from one another in substantially vertical alignment. The bores 104 and 106 intersect with the mortise 102. The bore 104 receives the key cylinder 38 (not shown in FIG. 9) and the spindle 32 (not shown in FIG. 9). It will be appreciated that the escutcheon plates 36 and 37 cover the round bores 104 and 106 without additional modification to the door body 100. Smaller diameter bores 104 and 106 as compared to the prior art provide a sleeker, more aesthetically pleasing door, as shown in FIG. 4. The present invention requires less door preparation and can easily be accomplished by the end user, rather than performed by the door manufacturer. Standard escutcheon plates 28, 36, easily cover the bores 104 and 106 as shown in FIG. 4.

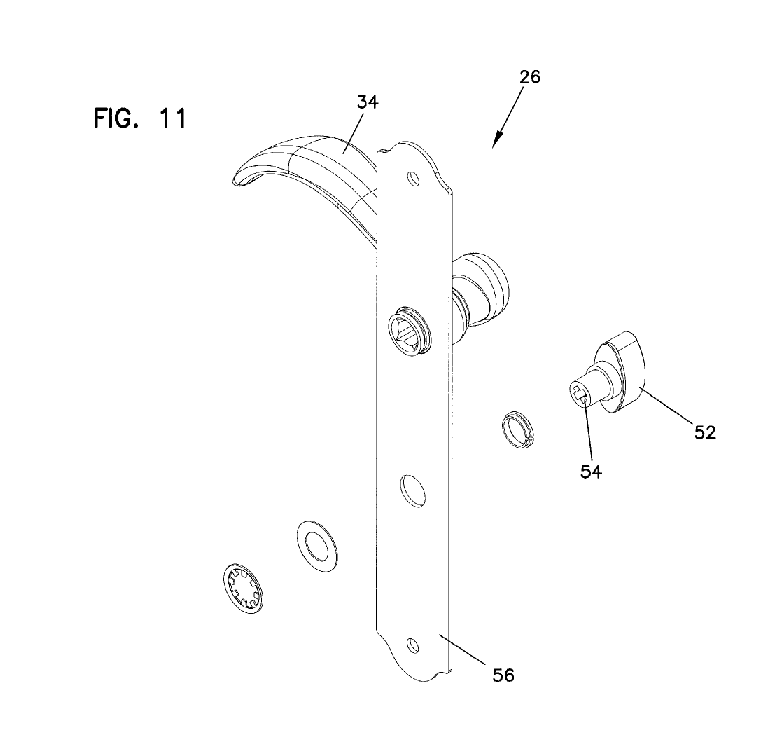

As shown in FIG. 2, the latch 22 has a thumb turn button 52, which is configured for receiving the spindle 74, as more clearly shown in FIG. 3. Referring again to FIG. 6, the key cylinder spindle 74 is loosely rotatably mounted to the key cylinder 38. In a preferred embodiment, there is approximately 90 degrees of relative free rotation between the key cylinder 38 and the spindle 74. This provides for actuation by either the key cylinder or the thumb turn button 52. Actuation of the dead bolt is required by less than a full turn, which is required in the prior art. In a preferred embodiment, approximately 90 degrees of rotation actuates the dead bolt between the extended locked position and the retracted unlocked position. With a small amount of rotation, the thumb turn button 52 may be actuated by rotation between a locked and unlocked position with a change in orientation, providing a quick visual indication whether the latch is locked or unlocked. As shown in FIG. 11, the thumb turn button 52 has crossing mounting slots 54 configured to receive the spindle 74. The mounting slots 54 are perpendicular to one another; so that the thumb turn button 52 may be oriented correctly even in a mounting configuration requires the flat portion of the spindle 74 to be horizontal or vertical. This provides for correct orientation and actuation for doors mounted to open either to the left or the right.

Referring now to FIGS. 5 and 7-9, the dead bolt 46 slidably mounts in the lock body 30. A cam 42, as well as the entire dead bolt assembly and live bolt assembly, is retained between side plates 44 and 45. Stakes 50 extend between the plates 44 and 45 to provide a housing for retaining the lock assemblies. An edge plate 80 covers up the mortise and provides orifices receiving the dead bolt 46 and live bolt 82. The live bolt 82 is actuated by the spindle 74 (not shown in FIG. 5) extending through an actuator 64 having a substantially square orifice. Rotation of the actuator 64 slides the live bolt 82 with rotation in a first direction, extending the live bolt 82 to a latched position extending beyond the side plate 45. Rotation in an opposite direction retracts the live bolt 82 into the orifice in the side plate 45. The actuator 64 includes an arm 66 that moves the live bolt 82 between the open and closed position. A spring biases the live bolt 82 towards the extended position and it returns the live bolt 82 and the handles 34 to their home position. Rotation of the live bolt 82 is limited by a stop 70 on the actuator 64 that extends through the orifice 76 formed in side plate 44. A radially outward extending section 77 of the orifice 76 subtending a limited angle limits rotation. The stop 70 engages the edges of the radially outward extending section 77 when the actuator 64 rotates between the open and closed positions.

As also shown in FIG. 5, dead bolt 46 includes a sliding dead bolt stop 48 extending through a slot 78 formed in the side plate 44. Slot 78 includes a tab 79 extending up into the slot 78 and forming channels 78A and 78B. The stop 48 moves from an unlocked position in channel 78B beside the tab 79, up over the tab 79, to a locked position on the other side of the tab 79 in channel 78A. Movement of the stop 48 is reversed for unlocking the dead bolt 46.

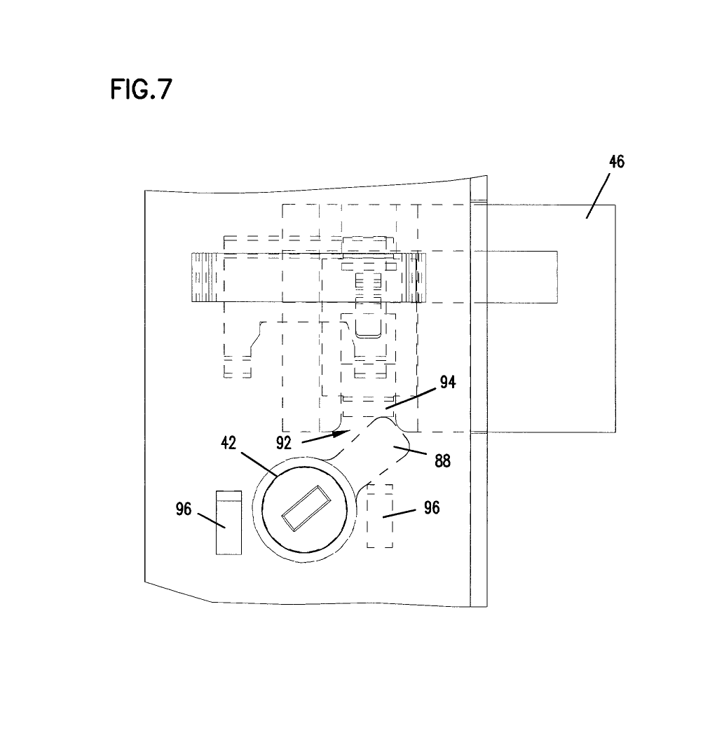

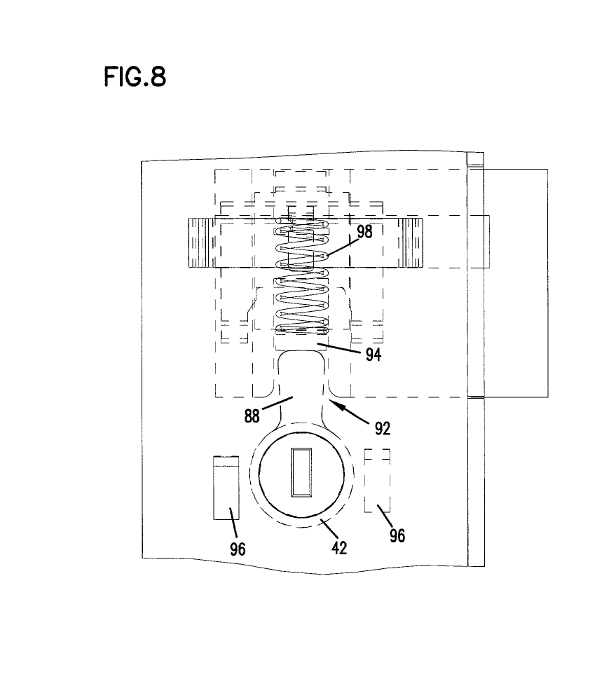

Referring now to FIGS. 7-9, cam 42 includes an extended arm portion 88 that protrudes into a recess 92 associated with the dead bolt 46. A spring 90 forces a sliding follower 94 downward to engage the cam arm 88 in recess 92. The follower slides with the stop 48, shown in FIG. 5. As shown in FIG. 7, in the locked position, the arm 88 is partially inserted into the recess 92. At this position, the dead bolt 46 is extended and the stop 48 is to the left of the tab 79 in slot 78A, as viewed in FIG. 5. As either the thumb turn button 52 or the key cylinder 38 is actuated, the cam 42 is rotated to the position shown in FIG. 8. The spring 90 is compressed as arm 88 extends further into recess 92. The follower 94 is raised, which moves the stop 48 upward so that it may clear the tab 79 in the slot 78. As rotation proceeds, stop 48 slides rightward as viewed in FIG. 5, above the tab 79. As shown in FIG. 9, when the dead bolt 46 is fully retracted in the unlocked position, the cam 42 is rotated fully to the left so that the arm 88 retracts further, but still protrudes into the recess 92. The follower 94 is pushed downward so that the stop 48 shown in FIG. 5 is in the channel 78B to the right of the tab 79, and is retained there. Movement of the stop 48 from slot 78B to slot 78A extends the dead bolt 46 to a locked position. The tab 79 and the slot 78 prevent further opening and over rotation of the cam 42 and an unwanted lock out situation. As also shown in FIGS. 7-9, stops 96 extend on opposed sides of the cam 42 for providing a positive mechanical stop against the arm 88. The stops 96 provide a separate safeguard to prevent over rotation of the cam and the lockout situation commonly associated with other existing mortise locks. The stops 96 provide a positive stop again further rotation of the cam 42 at both the locked and unlocked positions in addition to safeguards provided by the slot 78 and stop 48. In this manner, the arm 88 is maintained slightly extending into the recess 92 at all times and cannot become disengaged. Contact is maintained by the spring 96, which pushes downward against the follower 94.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A mortise latch apparatus, the latch comprising:
a key cylinder;
a first spindle;
a handle mounted to the first spindle; and
a lock assembly, including:
a housing;
a live bolt slidably mounted in the housing and actuated between an extended and retracted position, wherein the first spindle actuates the live bolt;
a cam rotating in the housing, wherein the cam includes an orifice engaging the key cylinder and is actuated by the key cylinder;
a dead bolt slidably mounted in the housing and sliding between a locked position and an unlocked position, wherein the cam engages the dead bolt and rotation of the cam in a first direction moves the dead bolt to the locked position, and rotation of the cam in a second direction moves the dead bolt to the unlocked position.

2. A latch apparatus according to claim 1, wherein the key cylinder includes a second spindle passing through the orifice in the cam.

3. A latch apparatus according to claim 1, wherein the dead bolt comprises a thumb button engaging the second spindle.

4. A latch apparatus according to claim 4, wherein the second spindle is freely rotatable about one half rotation from the key cylinder.

5. A latch apparatus according to claim 1, further comprising an opposed second handle engaging the first spindle.

6. A latch apparatus according to claim 1, wherein the live bolt is biased toward the extended position.

7. A latch apparatus according to claim 6, wherein the spindle passes through a rotatably mounted actuator having an arm engaging the live bolt.

8. A latch apparatus according to claim 1, wherein the cam includes a cam arm engaging a recess in the dead bolt.

9. A latch apparatus according to claim 1, wherein the dead bolt includes a follower extending through a slot in the housing, wherein the slot limits motion of the dead bolt.

10. A latch apparatus according to claim 7, wherein a portion of the actuator extends through the housing, and wherein the housing includes an actuator opening limiting rotation of the actuator.

11. A latch apparatus according to claim 10, wherein the cam arm lifts the follower, wherein the slot includes a first channel receiving the follower at a retracted dead bolt position and a second channel receiving the follower at an extended dead bolt position.

12. A latch apparatus according to claim 1, wherein the dead bolt is extended in the locked position and retracted in the unlocked position.

13. A latch apparatus according to claim 3, wherein the thumb turn button comprises crossed mounting slots.

14. A storm door, comprising:
a door body having opposed faces and an edge, wherein the edge has a mortise formed therein;
a latch inserting into the mortise, the latch including:
a key cylinder;
a lock assembly, including:
a housing;
a live bolt slidably mounted in the housing and actuated between an extended and retracted position;
a cam rotatably mounted in the housing, wherein the cam includes an orifice engaging the key cylinder and is actuated by the key cylinder;
a dead bolt slidably mounted in the housing and sliding between a locked position and an unlocked position, wherein the cam engages the dead bolt and rotation of the cam in a first direction moves the dead bolt to the locked position and rotation of the cam in a second direction moves the dead bolt to the unlocked position;
a handle on each face of the door; and
a spindle extending from one handle through the door to the other handle, wherein the spindle actuates the live bolt.

15. A door according to claim 14, wherein the latch is reversibly mountable to the door.

16. A lock apparatus, comprising:
a housing;
a live bolt slidably mounted in the housing and actuated between an extended and retracted position;
a cam rotating in the housing and having an axis of rotation transverse to the housing, wherein the cam includes an orifice engaging the key cylinder and is actuated by the key cylinder;
a dead bolt slidably mounted in the housing and sliding between a locked position and an unlocked position, wherein the cam engages the dead bolt, rotation of the cam in a first direction moves the dead bolt to the locked position, and rotation of the cam in a second direction moves the dead bolt to the unlocked position.

17. A method of mounting a latch to a storm door, comprising the steps of:
providing a latch having an oval key cylinder mounted to an escutcheon plate; a first spindle and a handle mounted to the first spindle; and a lock assembly including a housing, a live bolt slidably mounted in the housing and actuated by the first spindle, a cam rotating in the housing, wherein the cam includes an orifice engaging the key cylinder and is actuated by the key cylinder, and a dead bolt slidably mounted in the housing and sliding between a locked position and an unlocked position;
forming a mortise along one edge of the door;
forming first and second round bores through the door from one face to the other, wherein the bores intersect the mortise;
inserting the lock assembly in the mortise;
inserting the first spindle in the first round bore so as to actuate the live bolt; and
inserting the key cylinder in the second round bore and the orifice in the cam.

18. A method according to claim 17, wherein the first and second round bores are vertically aligned.
